(19) United States
(12) Patent Application Publication
(10) Pub. No.: US 2014/0288200 A1
(43) Pub. Date: Sep. 25, 2014

(54) HIGH COMPRESSIVE STRENGTH EXTRUDED POLYMERIC FOAM

(71) Applicants: Roy E. Smith, Midland, MI (US); Stephanie A. Donati, Westerville, OH (US)

(72) Inventors: Roy E. Smith, Midland, MI (US); Stephanie A. Donati, Westerville, OH (US)

(73) Assignee: DOW GLOBAL TECHNOLOGIES LLC, Midland, MI (US)

(21) Appl. No.: 14/355,741

(22) PCT Filed: Nov. 27, 2012
(86) PCT No.: PCT/US2012/066568

§ 371 Date: May 1, 2014

Related U.S. Application Data
(60) Provisional application No. 61/566,802, filed on Dec. 5, 2011.

(51) Int. Cl. C08J 9/14

(52) U.S. Cl. CPC C08J 9/147
USPC 521/97

(57) ABSTRACT

Prepare an extruded polymeric foam using a foamable polymer composition that contains a polymer composition with styrene-acrylonitrile copolymer, a blowing agent composition with only 1,1,1,2-tetrafluoroethane (74-78 weight-percent), carbon dioxide (13-16 weight-percent) and water (7-9 weight-percent) where the concentrations are relative to total blowing agent weight, and less than 0.5 weight-percent filler based on foamable polymer composition weight by using an extrusion foaming process with a foaming temperature of 120-125 degrees Celsius to produce a polymeric foam having a density of 29-37 kilograms per cubic meter and a vertical compressive strength in kilopascals having a magnitude exceeding 520 less than the product of the magnitude of the foam density in kilograms per cubic meter and 25.9.

### BACKGROUND OF THE INVENTION

1. Field of the Invention

The present invention relates to a process for preparing extruded polymeric foam having a high compressive strength.

2. Introduction

Polymeric foam is used in the building industry in many different ways including load bearing applications such as in highway structures, roofing applications and geo-technical applications. Polymeric foam used in load bearing applications requires a greater compressive strength than polymeric foam used, for example, as vertical cavity insulation. One way to increase the compressive strength properties of polymeric foam is by increasing the density of the polymeric foam. Increasing the foam density increases the amount of polymer in the struts or cell walls between cells and thereby increases the compressive strength. However, high thermal insulating properties are often desirable in applications for which a high compressive strength is desirable. Increasing foam density beyond approximately 48 kilograms per cubic meter tends to cause the thermal insulating properties of the foam to decrease, which is undesirable. The increased polymer in the foam also increases the cost of the resulting polymer foam over lower density foam. Therefore, it is undesirable to achieve higher compressive strength by increasing foam density.

U.S. Pat. No. 4,840,976 ('976) discloses a high compressive strength foam made using a blowing agent comprising ethyl chloride. Chlorinated blowing agents have become undesirable blowing agents due to environmental concerns. U.S. Pat. No. 5,006,566 ('566) discloses a high compressive strength foam using a blowing agent comprising 80-100 percent carbon dioxide. Carbon dioxide is a challenging blowing agent to employ in the preparation of polymeric foam so it is desirable to minimize the amount of carbon dioxide in the blowing agent.

It would advance the art of load bearing polymeric foam to discover method for preparing polymeric foam having a density below 48 kilograms per cubic meter, especially below 40 kilograms per cubic meter and even more desirably 37 kilograms per cubic meter or less and a vertical compressive strength that exceeds that otherwise achievable at such a density while avoiding use of chlorinated blowing agents and by using a blowing agent composition that is less than 20 weight-percent carbon dioxide based on total blowing agent weight. In particular, it is desirable to achieve such foam that has a vertical compressive strength of 275 kiloPascals or more and a density of 37 kilograms per cubic meter or less.

### BRIEF SUMMARY OF THE INVENTION

The present invention provides and advancement in the art of polymeric foam by identifying a method for preparing polymeric foam having a density below 48 kilograms per cubic meter, especially below 40 kilograms per cubic meter and even more desirably 37 kilograms per cubic meter or less and a vertical compressive strength that exceeds that otherwise achievable at such a density while avoiding use of chlorinated blowing agents and by using a blowing agent composition that is less than 20 weight-percent carbon dioxide based on total blowing agent weight. The process of the present invention can prepare such foam that has a vertical compressive strength of 275 kiloPascals or more, even 350 kiloPascals or more and at the same time a density of 37 kilograms per cubic meter or less.

Surprisingly, the present invention arises out of a discovery that a particular polymer composition in combination with a particular blowing agent composition and a specific foaming temperature produces extruded polymeric foam having the desirable combination of vertical compressive strength and density.

In a first aspect, the present invention is A process for preparing an extruded polymeric foam comprising the following steps: (a) providing a foamable polymer composition comprising a polymer composition and a blowing agent composition in an extruder at a mixing temperature and mixing pressure; (b) cooling the foamable polymer composition to a foaming temperature below the mixing temperature; and (c) expelling the foamable polymer composition through an extrusion die at the foaming temperature into an environment at a foaming pressure, the foaming pressure being lower than the mixing pressure and sufficiently low to allow the foamable polymer composition to expand into a polymeric foam; wherein the process is characterized by the polymer composition comprising alkenyl aromatic polymers at least one of which is a styrene-acrylonitrile copolymer and the blowing agent composition consists of 74-78 weight-percent 1,1,1,2-tetrafluoroethane, 13-16 weight-percent carbon dioxide and 7-9 weight-percent water with weight-percent based on total blowing agent composition weight, the foamable polymer composition comprising less than 0.5 weight-percent filler based on foamable polymer composition weight, the foaming temperature being in a range of 120-125 degrees Celsius, and the resulting polymeric foam having a density as determined by ASTM D1622 of 29 kilograms per cubic meter or greater and 37 kilograms per cubic meter or less and a vertical compressive strength in kilopascals as determined by ASTM D 1621 that has a magnitude exceeding 520 less than the product of 25.9 and the magnitude of the foam density in kilograms per cubic meter.

The process of the present invention is useful for preparing extruded polymeric foam having high compressive strength.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to American Society for Testing and Materials; EN refers to European Norm; DIN refers to Deutsches Institut für Normung; and ISO refers to International Organization for Standards.

“Multiple” means two or more. “And/or” means “and, or as an alternative”. All ranges include endpoints unless otherwise indicated.

The present process is an extrusion foam process. An extrusion foam process requires providing a foamable polymer composition comprising a polymer composition and a blowing agent composition in an extruder at a mixing temperature and a mixing pressure; cooling the foamable polymer composition to a foaming temperature that is below the mixing temperature and then expelling the foamable polymer composition through an extrusion die at the foaming temperature and into an environment at a foaming pressure. The foaming pressure is lower than the mixing pressure and sufficiently low so as to allow the foamable polymer composition to expand into polymeric foam.

The extrusion process can be any known in the art of extrusion foaming provided the conditions set forth herein are met. For example, the extrusion foaming process can use a conventional two-extruder tandem system with each extruder having a single screw. Alternatively, the extrusion foaming process can be a two-extruder tandem system in which the primary extruder is a twin screw and the second extruder has a single screw. A single screw extruder with proper cooling can also be suitable for use in the present invention.

The polymer composition of the present invention consists of all of the polymers in the foamable polymer composition and is characterized as comprising alkenyl aromatic polymers, at least one of which is a styrene-acrylonitrile (SAN) copolymer. The foamable polymer composition can comprise polymers other than alkenyl aromatic polymer or consist only of alkenyl aromatic polymers. Desirably, the polymer composition is more than 50 weight-percent (wt %), preferably 75 wt % or more, still more preferably 85 wt % or more, and yet more preferably 90 wt % or more alkenyl aromatic polymers relative to total polymer composition weight. The polymer composition can be 95 wt % or more, 98 wt % or more and even 100 wt % alkenyl aromatic polymer relative to total polymer composition weight. The alkenyl aromatic polymer is desirably selected from SAN copolymer and polystyrene homopolymer. Most preferably, the alkenyl aromatic polymer is SAN copolymer. It is desirable for the polymer composition to have a continuous phase of thermoplastic polymer, preferably to be at least 90 wt % thermoplastic polymer and can be entirely thermoplastic polymer.

In one embodiment of the present invention, the polymer composition consists of the alkenyl aromatic polymer and up to 5 wt %, preferably up to one wt %, even more preferably up to 0.5 wt % polyethylene (desirably linear low density polyethylene) relative to total polymer composition weight. Polyethylene is advantageously present often as a carrier resin for additives and sometimes as a cell size controlling agent.

Copolymerized acrylonitrile (AN) is desirably present at a concentration of 10 wt % or more, preferably 13 wt % or more and at the same time desirably 20 wt % or less, preferably 17 wt % or less relative to the total weight of polymer composition. Most desirably, the copolymerized AN is present at a concentration of 14-16 wt % and most preferably 15 wt % relative to the total weight of the polymer composition. In that regard, the polymer composition may contain SAN copolymers having different amounts of copolymerized AN, and/or a blend of SAN copolymers with polymers not containing copolymerized AN yet the total amount of copolymerized AN desirably falls within these ranges based on total polymer composition weight. For example, the polymer composition can consist of equal amounts of a SAN copolymer comprising 12 wt % copolymerized AN and an SAN copolymer comprising 16 wt % copolymerized AN to form a polymer composition having a copolymerized AN concentration of 14 wt %. The total amount of copolymerized AN in the polymer composition, as opposed to in any one copolymer, is important. If the concentration of AN exceeds 20 wt % of the SAN copolymer weight the polymer composition becomes difficult to foam. If the concentration of AN is less than 10 wt % the solubility of the blowing agent composition of the present invention becomes so low that it is difficult to achieve the desired foam density and uniform cell structure become elusive. Determine the concentration of AN relative to the total weight of polymer composition using Fourier transfer infrared (FTIR) spectroscopy by measuring relative FTIR peak absorption intensities as taught by Sargent, et al, in Styrene-Acrylonitrile Copolymers, Applied Spectroscopy, 45, 10, pp. 1726-1732 (1991).

Additionally, it is desirable for the SAN copolymer in the polymer composition to have a copolymerized AN concentration of 5 wt % or more, preferably 10 wt % or more and more preferably 13 wt % or more and at the same time 25 wt % or less, preferably 20 wt % or less and still more preferably 17 wt % or less relative to total SAN copolymer weight. Yet more desirably, the SAN copolymer has a copolymerized AN concentration of 14-16 wt % and most desirably 15 wt % relative to total SAN copolymer weight. SAN copolymers having copolymerized AN in these concentration ranges offer both the benefit of providing AN to the total polymer composition and yet remain easily processable in an extrusion foaming line. When the amount of copolymerized AN exceeds 25 wt % of a copolymer weight, the copolymer becomes difficult to process in an extrusion foaming process. Determine the concentration of AN in an SAN copolymer using FTIR spectroscopy as stated above.

In addition to these preferred levels of copolymerized AN, it is desirable for the SAN copolymer to have a weight-average molecular weight (Mw) of 115,000 grams per mole (g/mol) or more, preferably 125,000 g/mol or more and still more preferably 128,000 g/mol or more and at the same time 180,000 g/mol or less, preferably 150,000 g/mol or less, still more preferably 140,000 or less, yet more preferably 132,000 or less. Most desirably the SAN copolymer has a Mw of 130,000 g/mol, plus or minus 1000 g/mol. If the Mw is below 115,000 g/mol the foamable polymer composition is difficult to expand into desirable foam thicknesses. If the Mw is above 180,000 g/mol then the viscosity of the foamable polymer composition becomes so high that it is difficult to prepare quality foam. Determine Mw for an SAN copolymer according to ASTM D5296-11.

The SAN copolymer can further be characterized by a polydispersity index (Mw/Mn), which is the ratio of Mw to number average molecular weight (Mn) for the copolymer. Desirably, the SAN copolymer has a Mw/Mn of 2.0 or higher, preferably 2.1 or higher and still more preferably 2.2 or higher and at the same time 2.9 or lower, preferably 2.7 or lower, still more preferably 2.5 or lower. Most desirably, the SAN copolymer has a

Mw/Mn of approximately 2.35. Determine Mn for an SAN copolymer according to ASTM D5296-11.

The blowing agent composition of the present invention consists of a combination of three blowing agents: 1,1,1,2-tetrafluoroethane (HFC-134a), carbon dioxide and water. The amount of HFC-134a is 74 wt % or more, preferably 75 wt % or more and can be 76 wt % or more while at the same time is 78 wt % or less, preferably 77 wt % or less of the total blowing agent composition weight. The concentration of carbon dioxide is 13 wt % or more, preferably 14 wt % or more and at the same time is 16 wt % or less, and can be 15 wt % or less of the total blowing agent composition weight. The concentration of water is 7 wt % or more and 9 wt % or less of the total blowing agent composition weight. The sum of HFC-134a, carbon dioxide and water accounts for 100 wt % of the total blowing agent composition.

The foamable polymer composition can comprise additional additives in addition to the polymer composition and blowing agent composition. For example, the foamable polymer composition can comprise any one or any combination of more than one of the following: flame retardants (for example, brominated polymers and phosphorous containing compounds), antioxidant additives (for example, primary and secondary antioxidants and blends thereof), nucleating agents (for example, talc, magnesium silicate and calcium carbonate), extrusion aids (for example, zinc stearate and barium stearate), infrared attenuating agents (for example, graphite and carbon black), and colorants. The total amount of additional additives is desirably less than two wt % relative to total polymer composition weight. Moreover, the total amount of additional additives that are insoluble in the SAN copolymer of the polymer composition is 0.5 wt % or less based on total polymer composition weight. The foamable polymer composition can be free of any one or more than one of the above-mentioned additional additives. For example, foamable polymer composition can be free of infrared attenuating agents.

There is no known limitation as to how to provide the foamable polymer composition into an extruder. As one illustrative example, the polymer composition can be fed into an extruder and heated to a temperature sufficient to soften the polymer composition. Typically, the polymer composition is heated sufficiently to melt the thermoplastic polymers of the polymer composition. Under this illustrative example, blowing agent composition is added to the polymer composition while it is in a softened state and mixed into the polymer composition to form a foamable polymer composition. Additional additives can be added with the polymer composition or after the polymer composition has been melted, but are commonly added with the polymer composition.

The temperature of the foamable polymer composition is initially at a mixing temperature and mixing pressure. The mixing temperature is sufficiently high to soften the polymer composition, typically a temperature above the melting temperature for the thermoplastic polymers in the polymer composition. For example, the mixing temperature is typically 175 degrees Celsius (° C.) or higher, preferably 190° C. or higher and at the same time is typically 225° C. or lower, preferably 210° C. or lower. The mixing pressure is sufficiently high so as to preclude expansion of the blowing agent composition. The mixing pressure is typically 35 megaPascals (MPa) or less and at the same time 10 MPa or more.

The foamable polymer composition is then cooled from the mixing temperature to a foaming temperature that is below the mixing temperature. The foaming temperature is desirably 120° C. or higher, preferably 121° C. or higher and at the same time is desirably 125° C. or lower, preferably 124° C. or lower. Meanwhile, the pressure on the foamable polymer composition is still sufficiently high so as to preclude expansion of the blowing agent.

The foamable polymer composition is then expelled through an extrusion die at the foaming temperature into an environment that is at a foaming pressure. The foaming pressure is below the mixing pressure and is sufficiently low so as to allow expansion of the blowing agent. Typically, the expansion pressure is 110 kiloPascals or less. As the blowing agent composition expands it expands the polymer composition into polymeric foam.

Surprisingly, the polymer composition expands into a polymeric foam having a particularly desirable combination of low density and high vertical compressive strength. Analysis of polymeric foam properties has revealed that it is particularly challenging to prepare polymeric foam, while following the polymer composition and blowing agent restrictions set forth above, that has a relationship between density and vertical compressive strength as set forth below:

vertical compressive strength (kilopascals)>[25.9 (density (kg/m³))−520]

where “>” means “greater than” or “exceeds”. That is, the magnitude of vertical compressive strength in kilopascals exceeds 520 less than the product of 25.9 and the magnitude of the foam's density in kilograms per cubic meter. For reference herein, the value of [25(density(in kg/m³))−520] is called the “Vertical Compressive Strength Index” or “VCS Index” for polymeric foam.

Nonetheless, the process of the present invention is capable of preparing extruded styrenic polymer foam where the magnitude of vertical compressive strength in kilopascals exceeds the magnitude of 25.9 times the density in kilograms per cubic meter less 520. Of particular interest, the process of the present invention is capable of preparing such a foam with a density of 48 kg/m³ or less, 40 kg/m³ or less and even 37 kg/m³ or less. Meanwhile, the vertical compressive strength can be 275 kiloPascals or more, even 350 kiloPascals or more according to ASTM D 1621.

The polymer foam prepared by the present invention is “extruded” polymeric foam. Extruded polymeric foam is characterized by having an absence of a polymer film networking skin extending throughout the foam structure and surrounding (enclosing) groups of cells within the foam, as is evident in expanded bead foam.

### EXAMPLES

Prepare the following Comparative Examples and Examples using a single screw extruder that feeds a rotary mixer. Feed into the extruder 100 weight-parts of a polymer composition comprising of 50 wt % of SAN A (15 wt % AN relative to SAN weight, Mw=144k and Mw/Mn =2.4) and 50 wt % of SAN B (15 wt % AN relative to SAN weight, Mw=116k and Mw/Mn =2.3), 0.8 weight-parts of hexabromocyclododecane, 0.11 weight-parts of Irganox™ B215 brand antioxidant (Irganox is a trademark of Ciba Specialty Chemicals Corporation), 0.11 weight-parts of epoxy cresol novolac (ECN1280 from

Huntsman Araldite), 0.15 weight-parts of talc, 0.3 weight-parts of barium stearate, 0.3 weight-parts of DOWLEX# 2247 brand linear low density polyethylene (DOWLEX is a trademark of The Dow Chemical Company), and 0.025 weight-parts of blue dye. Heat the polymer composition to a mixing temperature in a range of 175° C.-235° C.

Add a blowing agent composition to the polymer composition in the rotary mixer while at the mixing temperature and at a mixing pressure of 15 megaPascals to prepare a foamable polymer composition. The composition and concentration of the blowing agent is in Table 1 and Table 2.

Cool the foamable polymer composition to a foaming temperature of 121-124° C. and expel the foamable polymer composition through an adjustable slot extrusion die having a 53 centimeter width and a variable die gap spacing into atmospheric pressure (101 kiloPascals) and atmospheric temperature (25° C.) and allow the foamable polymer composition to expand into a polymeric foam. Extrude the foamable polymer composition through the extrusion die at a rate of 1800 kilograms per hour.

Prepare Examples 1-4 using the blowing agent composition and foaming temperature as reported in Table 1. The resulting foam properties are also reported in

Table 1.

TABLE 1

| | Blowing Agent | | | | | | | |
|---|---|---|---|---|---|---|---|---|
| | (wt % of total Blowing | | | Total BA | | | | |
| | Agent weight) | | | (wt % based | | Vertical | | |
| | HFC- | | | on polymer | Foaming | Compressive | | |
| | 134a | | | composition | Temperature | Strength | Density | VCS |
| Example | Wt % | CO₂ | Water | weight) | (° C.) | (KPa) | (kg/m³) | Index |
| 1 | 77.5 | 15.0 | 7.5 | 9.35 | 122.5 | 431 | 35 | 386 |
| 2 | 77.0 | 15.9 | 7.1 | 9.42 | 122.5 | 450 | 35 | 386 |
| 3 | 76.7 | 14.8 | 8.5 | 9.45 | 123.0 | 387 | 33 | 335 |
| 4 | 77.0 | 15.9 | 7.1 | 9.42 | 123.5 | 317 | 32 | 309 |

Examples 1-4 illustrate that foam prepared according to the process of the present invention produces foam that surprisingly have a Vertical Compressive Strength that exceeds the VCS Index for the foam. In particular, Examples 1-3 simultaneously have a vertical compressive strength of at least 350 kiloPascals and a density of 35 kilograms per cubic meter or less.

Prepare Comparative Examples A-D using the blowing agent composition and foaming temperature as reported in Table 2. The resulting foam properties are also reported in Table 2.

TABLE 2

| | Blowing Agent | | | | | | | |
|---|---|---|---|---|---|---|---|---|
| | (wt % of total Blowing | | | Total BA | | | | |
| | Agent weight) | | | (wt % based | | Vertical | | |
| | HFC- | | | on polymer | Foaming | Compressive | | |
| Comparative | 134a | | | composition | Temperature | Strength | Density | VCS |
| Example | Wt % | CO₂ | Water | weight) | (° C.) | (KPa) | (kg/m³) | Index |
| A | 73.2 | 15.3 | 11.5 | 9.15 | 123.5 | 222 | 31 | 283 |
| B | 78.1 | 12.5 | 9.4 | 9.6 | 122.0 | 330 | 35 | 387 |
| C | 78.1 | 12.5 | 9.4 | 9.6 | 121.0 | 443 | 40 | 516 |
| D | 78.1 | 12.5 | 9.4 | 9.6 | 121.5 | 447 | 39 | 490 |

Comparative Examples A-D illustrate what happens to the density and vertical compressive strength when deviating from the blowing agent composition of the present invention. In contrast to Examples 1-4, the resulting foam is unable to achieve a vertical compressive strength that is greater than the VCS Index for the foam.

What is claimed is:

1. A process for preparing an extruded polymeric foam comprising the following steps:
a. providing a foamable polymer composition comprising a polymer composition and a blowing agent composition in an extruder at a mixing temperature and mixing pressure;
b. cooling the foamable polymer composition to a foaming temperature below the mixing temperature; and
c. expelling the foamable polymer composition through an extrusion die at the foaming temperature into an environment at a foaming pressure, the foaming pressure being lower than the mixing pressure and sufficiently low to allow the foamable polymer composition to expand into a polymeric foam;
wherein the process is characterized by the polymer composition comprising alkenyl aromatic polymers at least one of which is a styrene-acrylonitrile copolymer and the blowing agent composition consists of 74-78 weight-percent 1,1,1,2-tetrafluoroethane, 13-16 weight-percent carbon dioxide and 7-9 weight-percent water with weight-percent based on total blowing agent composition weight, the foamable polymer composition comprising less than 0.5 weight-percent filler based on foamable polymer composition weight, the foaming temperature being in a range of 120-125 degrees Celsius, and the resulting polymeric foam having a density as determined by ASTM D1622 of 29 kilograms per cubic meter or greater and 37 kilograms per cubic meter or less and a vertical compressive strength in kilopascals as determined by ASTM D 1621 that has a magnitude exceeding 520 less than the product of 25.9 and the magnitude of the foam density in kilograms per cubic meter.

2. The process of claim 1, wherein the foamable polymer composition is allowed to expand into a polymeric foam having a vertical compressive strength of at least 275 kiloPascals as determined by ASTM D 1621.

3. The process of claim 1, wherein the foamable polymer composition is allowed to expand into a polymeric foam having a vertical compressive strength of at least 350 kiloPascals as determined by ASTM D 162 land a density in a range of 29 kilograms per cubic meter or more and 35 kilograms per cubic meter or less as determined by ASTM D 1622.

4. The process of claim 1, wherein the alkenyl aromatic polymers consist of styrene-acrylonitrile copolymers.

5. The process of claims 1, wherein copolymerized acrylonitrile is present at a concentration of 15 weight-percent based on total alkenyl aromatic polymer weight.

6. The process of claim 1, wherein the alkenyl aromatic polymers consist of styrene-acrylonitrile copolymers and copolymerized acrylonitrile is present at a concentration of 15 weight-percent based on total styrenic polymer weight.
